(19) United States
(12) Patent Application Publication
(10) Pub. No.: US 2024/0159021 A1
(43) Pub. Date: May 16, 2024

(54) SYSTEMS AND METHODS FOR IMPLEMENTING INTEGRATED DISPLAYS FOR POWER MACHINES

(71) Applicant: Doosan Bobcat North America, Inc., West Fargo, ND (US)

(72) Inventors: Dennis Agnew, Moffit, ND (US); Sawyer Hanson, Fargo, ND (US)

(21) Appl. No.: 18/508,939

(22) Filed: Nov. 14, 2023

Related U.S. Application Data
(60) Provisional application No. 63/424,969, filed on Nov. 14, 2022.

(51) Int. Cl. E02F 9/26; B66F 9/065; B66F 9/075; E02F 9/16; G06F 3/14; H04N 7/18

(52) U.S. Cl. CPC E02F 9/261; B66F 9/0655; B66F 9/0755; B66F 9/0759; E02F 9/16; G06F 3/1423; H04N 7/183

(57) ABSTRACT

An integrated display system for power machines. The integrated display system includes a plurality of displays. Each of the plurality of displays are positioned between two layers of transparent material and at least two of the plurality of displays are integrated into different sides of a power machine.

### CROSS-REFERENCE TO RELATED APPLICATIONS

This application claims priority to U.S. Provisional Application No. 63/424,969, filed Nov. 14, 2022, the entire contents of which is incorporated herein by reference.

### BACKGROUND

This disclosure is directed toward power machines. More particularly, this disclosure is directed to excavators and display systems for excavators.

Power machines, for the purposes of this disclosure, include any type of machine that generates power to accomplish a particular task or a variety of tasks. One type of power machine is a work vehicle. Work vehicles are generally self-propelled vehicles that have a work device, such as a lift arm (although some work vehicles can have other work devices) that can be manipulated to perform a work function. Work vehicles include excavators, loaders, utility vehicles, tractors, trenchers, and telescopic handlers to name a few examples.

Excavators are a known type of power machine that have an undercarriage and a house that selectively rotates on the undercarriage. A lift arm to which an implement can be attached, is operably coupled to, and moveable under power with respect to, the house. Excavators are also typically self-propelled vehicles. Typical excavators include one or more operator input devices (e.g., joysticks or pedals) that are physically moved by an operator to directly adjust hydraulic fluid flow through a particular component of the excavator (e.g., a control valve for an actuator for a lift arm) thereby adjusting the movement of the particular component (e.g., the lift arm). For example, a joystick can be physically coupled to a hydraulic valve either through mechanical cables or linkages between the joystick and the hydraulic valve or through hydraulic signals that are controlled by the joystick (i.e., the use of what is commonly known as pilot operated joysticks), so that movement of the joystick directly changes the hydraulic valve position and thereby causes movement of an actuator and a component that is coupled to the actuator. Other examples of power machines include telescopic handlers (or telehandlers), loaders, and articulated vehicles.

The discussion above is merely provided for general background information and is not intended to be used as an aid in determining the scope of the claimed subject matter.

### SUMMARY OF THE DISCLOSURE

Some configurations of the disclosure are directed to power machines with an integrated display that allows the display of information, such as gauges, user inputs, mapped obstacles, boundaries, etc., including as can allow the operator of the power machine to see the displayed information closer to the line of sight with the work area. The display can show augmented reality information about a worksite in some cases, including as can allow an operator to effectively see through a lift arm or work implement.

Some configurations described herein provide a power machine. The power machine may include an operator station having a plurality of sides and supported by the frame. The operator station may include an operator input device configured to receive operator inputs to control movement of the lift arm. The operator station may include a display system configured to electronically display content, the display system having a set of displays that includes a first display integrated into a first side of the operator station and a second display integrated into a second side of the operator station. The power machine also includes a control system that includes a controller in electronic communication with the display system. The controller is configured to receive, from a sensor, operational data associated with the power machine and control the display system to display, via the first display and the second display, content associated with the operational data of the power machine.

Some configurations described herein provide a method. The method may include receiving, with one or more electronic processors, from an image sensor, operational data associated with a work element of a power machine. The method may include controlling, with the one or more electronic processors, a display system of the power machine to display, via a plurality of displays integrated into sides of an operator station of the power machine, content based on the operational data, wherein the power machine includes a telescopic lift arm and the image sensor is supported on a distal end of the telescopic lift arm.

Some configurations described herein provide an operator station for a power machine. The operator station may include a display system configured to display content, the display system having a set of displays that includes a first display integrated into a first side of the operator station and a second display integrated into a second side of the operator station; and the display system being in electronic communication with a control system that includes a controller in electronic communication with the display system, to be controlled by the controller to display content based on operational data of the power machine received by the controller.

This Summary and the Abstract are provided to introduce a selection of concepts in a simplified form that are further described below in the Detailed Description. The Summary and the Abstract are not intended to identify key features or essential features of the claimed subject matter, nor are they intended to be used as an aid in determining the scope of the claimed subject matter.

### BRIEF DESCRIPTION OF THE DRAWINGS

The following drawings are provided to help illustrate various features of examples of the disclosure and are not intended to limit the scope of the disclosure or exclude alternative implementations.

FIG. 1 is a block diagram illustrating functional systems of a representative power machine in accordance with some configurations.

FIG. 2 is a front left perspective view of a representative power machine in the form of an excavator in accordance with some configurations.

FIG. 3 is a rear right perspective view of the excavator of FIG. 2 in accordance with some configurations.

FIG. 4 is a front left perspective view of a representative power machine in the form of a telescopic handler in accordance with some configurations.

FIG. 5 schematically illustrates an example power machine according to some configurations.

FIG. 6 schematically illustrates a controller of the power machine of FIG. 5 according to some configurations.

FIG. 7 is a side perspective view of a representative operator station in accordance with some configurations.

FIG. 8 is a perspective view of a representative operator station in accordance with some configurations.

FIGS. 9A-9B illustrate a portion of an operator station with an integrated display material in accordance with some configurations.

FIGS. 10A-10B illustrate a set of layers associated with an integrated display material in accordance with some configurations.

FIG. 11 is a diagrammatic illustration of an integrated display having infrared light curtain devices positioned to provide a user input without the use of a touch sensitive material in accordance with some configurations.

FIG. 12 is a front left perspective view of the telescopic handler of FIG. 4 with an external sensor in accordance with some configurations.

FIG. 13 is a flowchart illustrating a method of controlling a display system of a power machine according to some configurations.

FIG. 14 illustrates example displayed content according to some configurations.

### DETAILED DESCRIPTION OF THE PRESENT DISCLOSURE

The concepts disclosed in this discussion are described and illustrated by referring to exemplary configurations. These concepts, however, are not limited in their application to the details of construction and the arrangement of components in the illustrative configurations and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

As generally noted above, power machines can be configured for various work operations. For example, power systems of wheeled and tracked power machines can be configured to power tractive systems for wheeled, tracked, skid-steer, or other movement over terrain, and to power workgroup systems for various (non-tractive) workgroup operations. with articulated, extendable, or otherwise configured lift arms.

During these various operations, it may be useful to keep operators apprised of various operational conditions. For example, an operator controlling the power machine to perform work operations may be able to use information about the operational state of various actuators of the power machine (e.g., speed, extension length, etc. for workgroup or tractive actuators), or the operational state of various work elements (e.g., a position, a speed, or a loading of a lift arm or components thereof, or of an implement operationally secured to the power machine).

Accordingly, examples of the disclosed technology can provide improved presentation of operational content on displays of power machines, including as can allow operators to more effectively control workgroups for work operations. Some examples can include electronic controllers configured to control the display of content on multiple sides of an operator station for a power machine. Some examples can include electronic controllers configured to control the display of video content or other operational data, including as can allow operators to view areas of a power machine or the surrounding environment that may be obscured by a lift arm or various other work elements. Some examples can include electronic controllers configured to control the display of operational data for components of a power machine, including as can provide real-time state information for various tractive or workgroup actuators, lift arm structures, implements, or other power machine components.

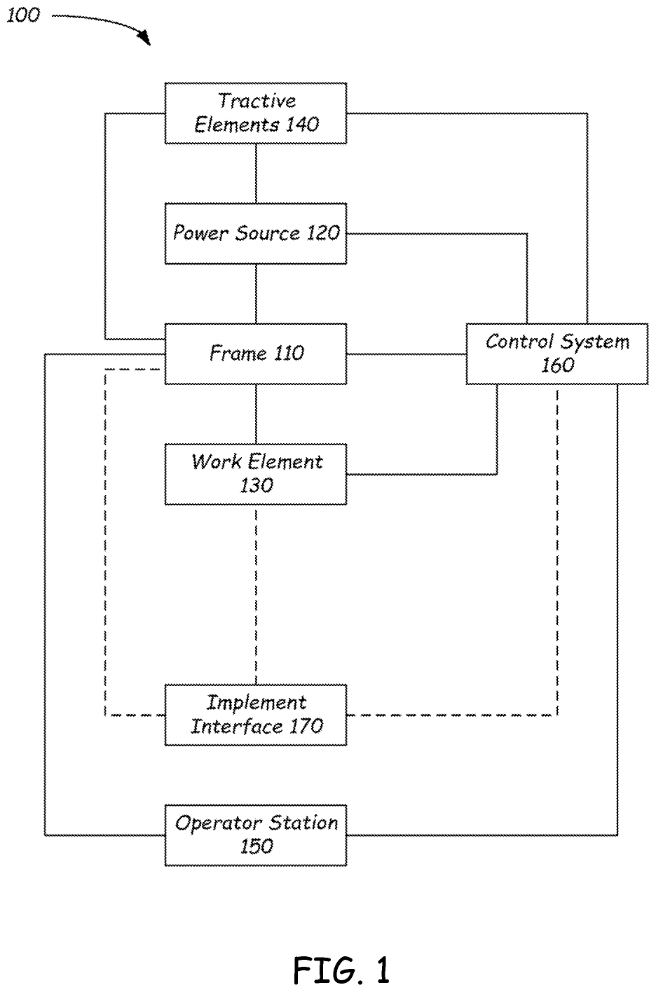

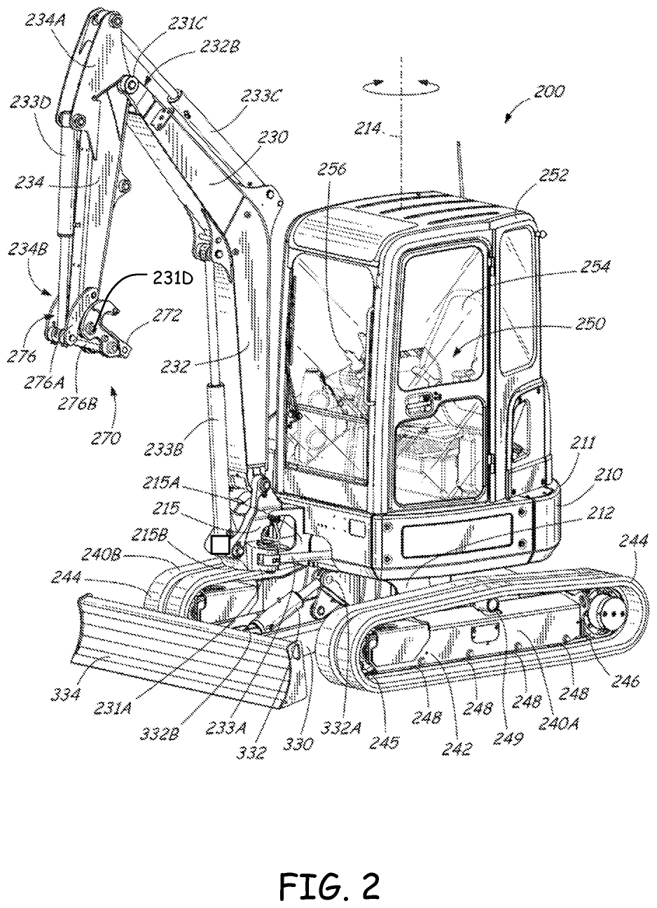

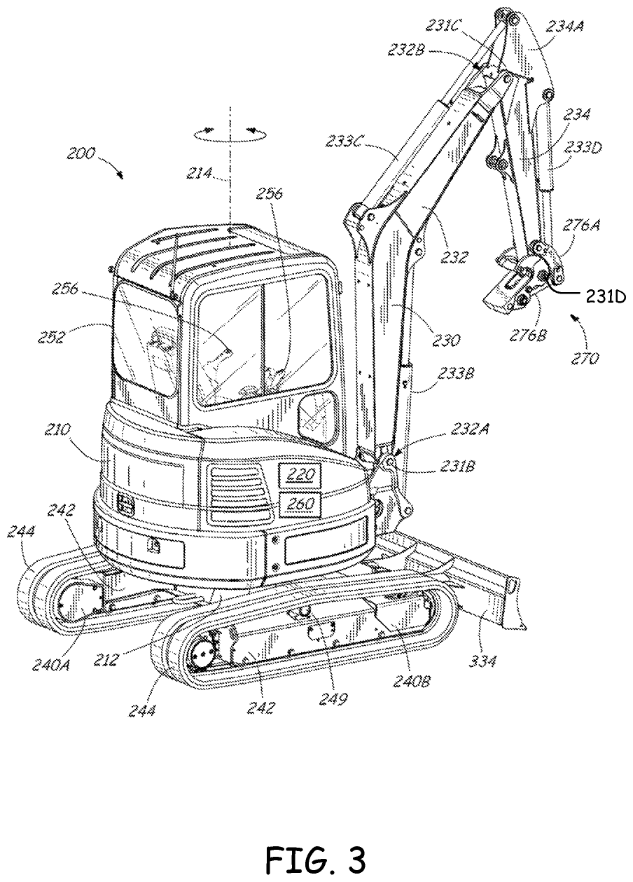

A representative power machine on which the embodiments can be practiced is illustrated in diagram form in FIG. 1 and one example of such a power machine is illustrated in FIGS. 2-3 and described below before any embodiments are disclosed. For the sake of brevity, only one power machine is discussed. However, as mentioned above, the embodiments below can be practiced on any of a number of power machines, including power machines of different types from the representative power machine shown in FIGS. 2-3. Power machines, for the purposes of this discussion, include a frame, at least one work element, and a power source that can provide power to the work element to accomplish a work task. One type of power machine is a self-propelled work vehicle. Self-propelled work vehicles are a class of power machines that include a frame, work element, and a power source that can provide power to the work element. At least one of the work elements is a motive system for moving the power machine under power.

Referring now to FIG. 1, a block diagram illustrates the basic systems of a power machine 100 upon which the embodiments discussed below can be advantageously incorporated and can be any of several distinct types of power machines. The block diagram of FIG. 1 identifies various systems on power machine 100 and the relationship between various components and systems. As mentioned above, at the most basic level, power machines for the purposes of this discussion include a frame, a power source, and a work element. The power machine 100 has a frame 110, a power source 120, and a work element 130. Because power machine 100 shown in FIG. 1 is a self-propelled work vehicle, it also has tractive elements 140, which are themselves work elements provided to move the power machine over a support surface and an operator station 150 that provides an operating position for controlling the work elements of the power machine. A control system 160 is provided to interact with the other systems to perform various work tasks at least in part in response to control signals provided by an operator.

Certain work vehicles have work elements that can perform a dedicated task. For example, some work vehicles have a lift arm to which an implement such as a bucket is attached such as by a pinning arrangement. The work element, e.g., the lift arm, can be manipulated to position the implement for performing the task. The implement, in some instances can be positioned relative to the work element, such as by rotating a bucket relative to a lift arm, to further position the implement. Under normal operation of such a work vehicle, the bucket is intended to be attached and under use. Such work vehicles may be able to accept other implements by disassembling the implement/work element combination and reassembling another implement in place of the original bucket. Other work vehicles, however, are intended to be used with a wide variety of implements and have an implement interface such as implement interface 170 shown in FIG. 1. At its most basic, implement interface 170 is a connection mechanism between the frame 110 or a work element 130 and an implement, which can be as simple as a connection point for attaching an implement directly to the frame 110 or a work element 130 or more complex, as discussed below.

On some power machines, implement interface 170 can include an implement carrier, which is a physical structure movably attached to a work element. The implement carrier has engagement features and locking features to accept and secure any of several implements to the work element. One characteristic of such an implement carrier is that once an implement is attached to it, it is fixed to the implement (i.e., not movable with respect to the implement) and when the implement carrier is moved with respect to the work element, the implement moves with the implement carrier. The term implement carrier is not merely a pivotal connection point, but rather a dedicated device specifically intended to accept and be secured to various different implements. The implement carrier itself is mountable to a work element 130 such as a lift arm or the frame 110. Implement interface 170 can also include one or more power sources for providing power to one or more work elements on an implement. Some power machines can have a plurality of work elements with implement interfaces, each of which may, but need not, have an implement carrier for receiving implements. Some other power machines can have a work element with a plurality of implement interfaces so that a single work element can accept a plurality of implements simultaneously. Each of these implement interfaces can, but need not, have an implement carrier.

Frame 110 includes a physical structure that can support various other components that are attached thereto or positioned thereon. The frame 110 can include any number of individual components. Some power machines have frames that are rigid. That is, no part of the frame is movable with respect to another part of the frame. Other power machines have at least one portion that can move with respect to another portion of the frame. For example, excavators can have an upper frame portion that rotates about a swivel with respect to a lower frame portion. Other work vehicles have articulated frames such that one portion of the frame pivots with respect to another portion for accomplishing steering functions. In exemplary embodiments, at least a portion of the power source is located in the upper frame or machine portion that rotates relative to the lower frame portion or undercarriage. The power source provides power to components of the undercarriage portion through the swivel.

Frame 110 supports the power source 120, which can provide power to one or more work elements 130 including the one or more tractive elements 140, as well as, in some instances, providing power for use by an attached implement via implement interface 170. Power from the power source 120 can be provided directly to any of the work elements 130, tractive elements 140, and implement interfaces 170. Alternatively, power from the power source 120 can be provided to a control system 160, which in turn selectively provides power to the elements that are capable of using it to perform a work function. Power sources for power machines typically include an engine such as an internal combustion engine and a power conversion system such as a mechanical transmission or a hydraulic system that can convert the output from an engine into a form of power that is usable by a work element. Alternatively, or in addition, other types of power sources can be incorporated into power machines, including electrical sources or a combination of power sources, known generally as hybrid power sources.

FIG. 1 shows a single work element designated as work element 130, but various power machines can have any number of work elements. Work elements are typically attached to the frame of the power machine and movable with respect to the frame when performing a work task. In addition, tractive elements 140 are a special case of work element in that their work function is generally to move the power machine 100 over a support surface. Tractive elements 140 are shown separate from the work element 130 because many power machines have additional work elements besides tractive elements, although that is not always the case. Power machines can have any number of tractive elements, some or all of which can receive power from the power source 120 to propel the power machine 100. Tractive elements can be, for example, wheels attached to an axle, track assemblies, and the like. Tractive elements can be rigidly mounted to the frame such that movement of the tractive element is limited to rotation about an axle or steerably mounted to the frame to accomplish steering by pivoting the tractive element with respect to the frame. In contrast to tractive elements and actuators, workgroup actuators and elements are configured to provide powered movement of one or more components of a power machine for work operations (i.e., other than for travel of the power machine over terrain). Correspondingly, “workgroup function” refers to one or more functions that relate to movement of one or more components of a power machine other than for travel of the power machine over terrain.

Power machine 100 includes an operator station 150, which provides a position from which an operator can control operation of the power machine. In some power machines, the operator station 150 is defined by an enclosed or partially enclosed cab. Some power machines on which the disclosed embodiments may be practiced may not have a cab or an operator compartment of the type described above. For example, a walk behind loader may not have a cab or an operator compartment, but rather an operating position that serves as an operator station from which the power machine is properly operated. More broadly, power machines other than work vehicles may have operator stations that are not necessarily similar to the operating positions and operator compartments referenced above. Further, some power machines such as power machine 100 and others, whether they have operator compartments or operator positions, may be capable of being operated remotely (i.e., from a remotely located operator station) instead of or in addition to an operator station adjacent or on the power machine. This can include applications where at least some of the operator-controlled functions of the power machine can be operated from an operating position associated with an implement that is coupled to the power machine. Alternatively, with some power machines, a remote-control device can be provided (i.e., remote from both of the power machine and any implement to which is it coupled) that can control at least some of the operator-controlled functions on the power machine.

FIGS. 2-3 illustrate an excavator 200, which is one particular example of a power machine of the type illustrated in FIG. 1, on which the disclosed embodiments can be employed. Unless specifically noted otherwise, embodiments disclosed below can be practiced on a variety of power machines, with the excavator 200 being only one of those power machines. Excavator 200 is described below for illustrative purposes. Not every excavator or power machine on which the illustrative embodiments can be practiced need have all the features or be limited to the features that excavator 200 has. Excavator 200 has a frame 210 that supports and encloses a power system 220 (represented in FIGS. 2-3 as a block, as the actual power system is enclosed within the frame 210). The power system 220 includes an engine that provides a power output to a hydraulic system. The hydraulic system acts as a power conversion system that includes one or more hydraulic pumps for selectively providing pressurized hydraulic fluid to actuators that are operably coupled to work elements in response to signals provided by operator input devices. The hydraulic system also includes a control valve system that selectively provides pressurized hydraulic fluid to actuators in response to signals provided by operator input devices. The excavator 200 includes a plurality of work elements in the form of a first lift arm structure 230 and a second lift arm structure 330 (not all excavators have a second lift arm structure). In addition, excavator 200, being a work vehicle, includes a pair of tractive elements in the form of left and right track drive assemblies 240A and 240B, which are disposed on opposing sides of the frame 210.

An operator compartment 250 is defined in part by a cab 252, which is mounted on the frame 210. The cab 252 shown on excavator 200 is an enclosed structure, but other operator compartments need not be enclosed. For example, some excavators have a canopy that provides a roof but is not enclosed A control system 260, shown as a block, is provided for controlling the various work elements. Control system 260 includes operator input devices, which interact with the power system 220 to selectively provide power signals to actuators to control work functions on the excavator 200. In some embodiments, the operator input devices include at least two two-axis operator input devices to which operator functions can be mapped.

Frame 210 includes an upper frame portion or house 211 that is pivotally mounted on a lower frame portion or undercarriage 212 via a swivel joint. The swivel joint includes a bearing, a ring gear, and a slew motor with a pinion gear (not pictured) that engages the ring gear to swivel the machine. The slew motor receives a power signal from the control system 260 to rotate the house 211 with respect to the undercarriage 212. House 211 is capable of unlimited rotation about a swivel axis 214 under power with respect to the undercarriage 212 in response to manipulation of an input device by an operator. Hydraulic conduits are fed through the swivel joint via a hydraulic swivel to provide pressurized hydraulic fluid to the tractive elements and one or more work elements such as lift arm structure 330 that are operably coupled to the undercarriage 212.

The first lift arm structure 230 is mounted to the house 211 via a swing mount 215. (Some excavators do not have a swing mount of the type described here.) The first lift arm structure 230 is a boom-arm lift arm of the type that is generally employed on excavators although certain features of this lift arm structure may be unique to the lift arm illustrated in FIGS. 2-3. The swing mount 215 includes a frame portion 215A and a lift arm portion 215B that is rotationally mounted to the frame portion 215A at a mounting frame pivot 231A. A swing actuator 233A is coupled to the house 211 and the lift arm portion 215B of the mount. Actuation of the swing actuator 233A causes the lift arm structure 230 to pivot or swing about an axis that extends longitudinally through the mounting frame pivot 231A.

The first lift arm structure 230 includes a first portion 232, known generally as a boom 232, and a second portion 234, known as an arm or a dipper. The boom 232 is pivotally attached on a first end 232A to mount 215 at boom pivot mount 231B. A boom actuator 233B is attached to the mount 215 and the boom 232. Actuation of the boom actuator 233B causes the boom 232 to pivot about the boom pivot mount 231B, which effectively causes a second end 232B of the boom to be raised and lowered with respect to the house 211. A first end 234A of the arm 234 is pivotally attached to the second end 232B of the boom 232 at an arm mount pivot 231C. An arm actuator 233C is attached to the boom 232 and the arm 234. Actuation of the arm actuator 233C causes the arm to pivot about the arm mount pivot 231C. Each of the swing actuator 233A, the boom actuator 233B, and the arm actuator 233C can be independently controlled in response to control signals from operator input devices.

An exemplary implement interface 270 is provided at a second end 234B of the arm 234. The implement interface 270 includes an implement carrier 272 that can accept and securing a variety of different implements to the lift arm structure 230. Such implements have a machine interface that is configured to be engaged with the implement carrier 272. The implement carrier 272 is pivotally mounted to the second end 234B of the arm 234. An implement carrier actuator 233D is operably coupled to the arm 234 and a linkage assembly 276. The linkage assembly includes a first link 276A and a second link 276B. The first link 276A is pivotally mounted to the arm 234 and the implement carrier actuator 233D. The second link 276B is pivotally mounted to the implement carrier 272 and the first link 276A. The linkage assembly 276 is provided to allow the implement carrier 272 to pivot about the arm 234 when the implement carrier actuator 233D is actuated.

The implement interface 270 also includes an implement power source (not shown in FIGS. 2-3) available for connection to an implement on the lift arm structure 230. The implement power source includes pressurized hydraulic fluid port to which an implement can be coupled. The pressurized hydraulic fluid port selectively provides pressurized hydraulic fluid for powering one or more functions or actuators on an implement. The implement power source can also include an electrical power source for powering electrical actuators and/or an electronic controller on an implement. The electrical power source can also include electrical conduits that are in communication with a data bus on the excavator 200 to allow communication between a controller on an implement and electronic devices on the excavator 200. It should be noted that the specific implement power source on excavator 200 does not include an electrical power source. However, in some configurations, the specific implement power source or other power sources of an excavator or other power machine can include an electrically powered actuator, for example, when the excavator is an electrically powered work vehicle that includes an electrical power storage device (e.g., a battery). Correspondingly, control of actuators in some cases may not necessarily require control of hydraulic flow (e.g., may be accomplished via electronic control of an electronic actuator by a control device).

The lower frame 212 supports and has attached to it a pair of tractive elements 240, identified in FIGS. 2-3 as left track drive assembly 240A and right track drive assembly 240B. Each of the tractive elements 240 has a track frame 242 that is coupled to the lower frame 212. The track frame 242 supports and is surrounded by an endless track 244, which rotates under power to propel the excavator 200 over a support surface. Various elements are coupled to or otherwise supported by the track frame 242 for engaging and supporting the track 244 and cause it to rotate about the track frame. For example, a sprocket 246 is supported by the track frame 242 and engages the endless track 244 to cause the endless track to rotate about the track frame. An idler 245 is held against the track 244 by a tensioner (not shown) to maintain proper tension on the track. The track frame 242 also supports a plurality of rollers 248, which engage the track and, through the track, the support surface to support and distribute the weight of the excavator 200. An upper track guide 249 is provided for providing tension on track 244 and preventing the track from rubbing on track frame 242.

A second, or lower, lift arm structure 330 is pivotally attached to the lower frame 212. A lower lift arm actuator 332 is pivotally coupled to the lower frame 212 at a first end 332A and to the lower lift arm structure 330 at a second end 332B. The lower lift arm structure 330 is configured to carry a lower implement 334, which in one embodiment is a blade as is shown in FIGS. 2-3. The lower implement 334 can be rigidly fixed to the lower lift arm structure 330 such that it is integral to the lift arm. Alternatively, the lower implement can be pivotally attached to the lower lift arm via an implement interface, which in some embodiments can include an implement carrier of the type described above. Lower lift arms with implement interfaces can accept and secure various different types of implements thereto. Actuation of the lower lift arm actuator 332, in response to operator input, causes the lower lift arm structure 330 to pivot with respect to the lower frame 212, thereby raising and lowering the lower implement 334.

Upper frame portion 211 supports cab 252, which defines, at least in part, operator compartment or station 250 (e.g., the operator station 150). A seat 254 is provided within cab 252 in which an operator can be seated while operating the excavator. While sitting in the seat 254, an operator will have access to a plurality of operator input devices 256 that the operator can manipulate to control various work functions, such as manipulating the lift arm structure 230, the lower lift arm structure 330, the tractive elements 240, pivoting the house 211, the tractive elements 240, and so forth.

Excavator 200 provides a variety of different operator input devices 256 to control various functions. For example, joysticks are provided to control the lift arm structure 230 and swiveling of the house 211 of the excavator. Foot pedals with attached levers (e.g., as represented by box 213 in FIG. 2 are provided for controlling travel and lift arm swing. Electrical switches are located on the joysticks for controlling the providing of power to an implement attached to the implement carrier 272. Other types of operator inputs that can be used in excavator 200 and other excavators and power machines include, but are not limited to, switches, buttons, knobs, levers, variable sliders, and the like. The specific control examples provided above are exemplary in nature and not intended to describe the input devices for all excavators and what they control.

Display devices are provided in the cab to give indications of information relatable to the operation of the power machines in a form that can be sensed by an operator, such as, for example audible, haptic, and/or visual indications. Audible indications can be made in the form of buzzers, bells, and the like or via verbal communication. A haptic indication can be made in the form of movement, vibration, etc. Visual indications can be made in the form of graphs, lights, icons, gauges, alphanumeric characters, and the like. Displays can provide dedicated indications, such as warning lights or gauges, or dynamic to provide programmable information, including programmable display devices such as monitors of various sizes and capabilities. Display devices can provide diagnostic information, troubleshooting information, instructional information, and various other types of information that assists an operator with operation of the power machine or an implement coupled to the power machine. Other information that may be useful for an operator can also be provided.

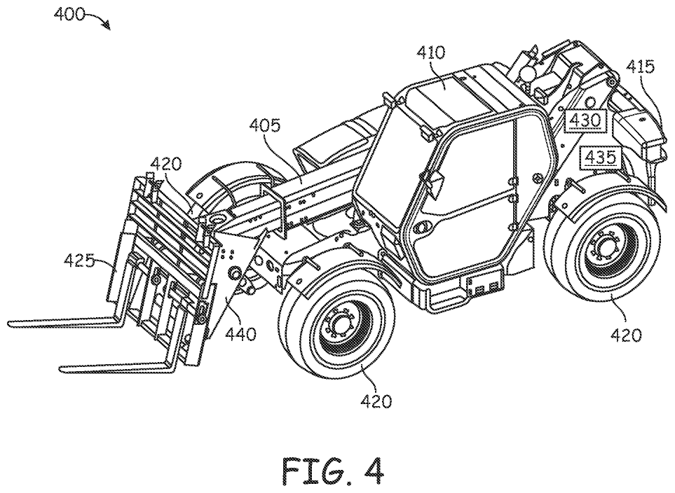

FIG. 4 illustrates a telescopic handler 400, which is another particular example of a power machine of the type illustrated in FIG. 1, on which the disclosed configurations can be employed. Unless specifically noted otherwise, configurations disclosed herein can be practiced on a variety of power machines, with the telescopic handler 400 being only one of those power machines. As illustrated in FIG. 4, the telescopic handler 400 may include similar components as the excavator 200. For instance, the telescopic handler 400 includes a lift arm 405, an operator station 410, a frame 415, one or more tractive elements 420, a work element 425, a control system 430, a power source 435, an implement interface 440, and the like. In some regards, however, the telescopic handler 400 differs from other power machines. For example, the lift arm 405 is a telescopic lift arm and can thus be moved between fully lowered and fully raised, as well as fully retracted and fully extended orientations. The telescopic handler 400 may include additional, different, or fewer components than those illustrated in the example of FIG. 4.

The description of power machine 100, excavator 200, and telescopic handler 400 above is provided for illustrative purposes, to provide illustrative environments on which the embodiments discussed below can be practiced. While the embodiments discussed can be practiced on a power machine such as is generally described by the power machine 100 shown in the block diagram of FIG. 1 and more particularly on an excavator 200 or a telescopic handler 400, unless otherwise noted, the concepts discussed below are not intended to be limited in their application to the environments specifically described above.

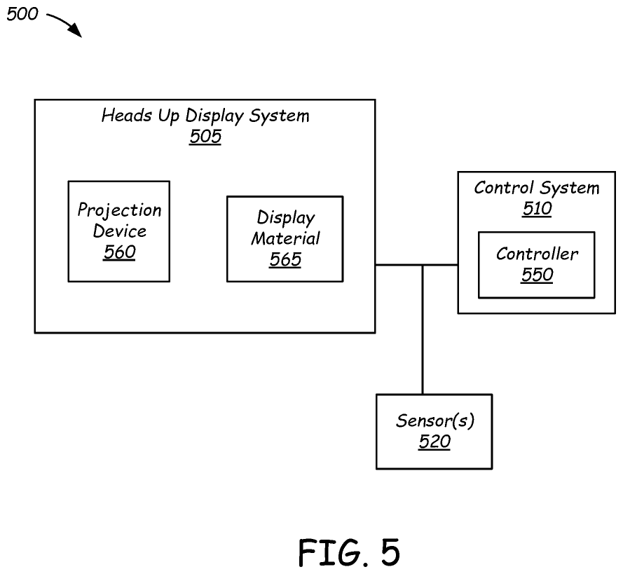

FIG. 5 is a schematic block diagram of a power machine 500, which can be any of a number of different types of power machines (e.g., wheeled or tracked skid-steer loaders, an excavator, a telescopic handler, etc.), including any of the types generally discussed above. The power machine 500 may include a heads-up display (“HUD”) system 505, a control system 510, and a set of sensors 520 (referred to herein collectively as “the sensors 520” and individually as “the sensor 520”). The HUD system 505, the control system 510, and the sensors 520 communicate over one or more communication lines or buses. The power machine 500 may include additional, fewer, or different components than those illustrated in FIG. 5 in various configurations and may perform additional functionality than the functionality described herein. For example, the power machine 500 may include additional, similar, or different components, systems, and functionality as described above with respect to the power machine 100 of FIG. 1, the excavator 200 of FIGS. 2-3, the telescopic handler 400 of FIG. 4, or another power machine described herein. As another example, in some configurations, one or more of the components illustrated in FIG. 5 may be included within an interior of an operator station. Alternatively, or in addition, in some configurations, one or more of the components illustrated in FIG. 5 may be included outside of an operator station (e.g., on an exterior of the operator station or another component of the power machine 500). As one example, the control system 510 or the sensors 520 may be positioned outside of the operator station.

In one example implementation of the power machine 500 of FIG. 5, the controller 550 receives data signals from the sensors 520 communicatively coupled thereto. One or more of the sensors 520 can be image sensors or cameras positioned about a periphery of the power machine 500, where the resulting data signals transmitted to the controller 550 may include image data. The controller 550 may then arrange the image data from the one or more sensors 520 with other operational data to be displayed to an operator of the power machine 500 via the HUD system 505. In accordance with the configuration illustrated in FIG. 5, the data to be projected by the HUD system 505 may be transmitted from the control system 510 to the projection device 560. The projection device 560 then projects the operational data upon a display within the cab of the power machine 500. The display may include one or more windows of the cab which have been augmented with a display material. As discussed in more detail below, the display material may be laminated to a (glass) window of the cab or sandwiched between two layers of the window. The display material itself may be a semi-reflective material that allows for increased reflection of light compared to a glass window while still maintaining operator visibility out of the cab. When the projected image from the projection device 560 (positioned within the cab) is projected onto the display material, a portion of the light travels through the glass and display material (out of the cab) and a second portion of the light is reflected to the operator. As a result, the operator may reference power equipment operational data on the one or more windows of the cab while maintaining visibility therethrough.

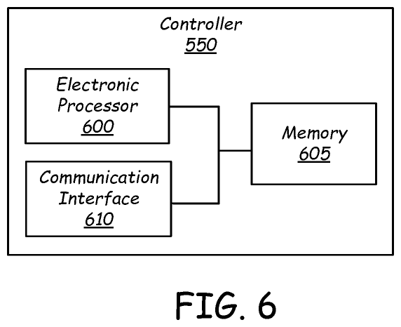

As illustrated in FIG. 5, the control system 510 includes a controller 550. FIG. 6 illustrates the controller 550 according to some configurations. In the illustrated example of FIG. 6, the controller 550 includes an electronic processor 600 (for example, a microprocessor, an application-specific integrated circuit (“ASIC”), or another suitable electronic device), a memory 605 (for example, a non-transitory, computer-readable medium), and a communication interface 610. The electronic processor 600, the memory 605, and the communication interface 610 communicate over one or more communication lines or buses. The controller 550 may include additional components than those illustrated in FIG. 6 in various configurations and may perform additional functionality than the functionality described herein. As one example, in some embodiments, the functionality described herein as being performed by the controller 550 may be distributed among other components or devices.

The communication interface 610 allows the controller 550 to communicate with devices external to the controller 550. As one example, as illustrated in FIG. 5, the controller 550 may communicate with the HUD system 505 (or component(s) therein), the sensor(s) 520, other components or systems of the power machine 500, or a combination thereof through the communication interface 610.

The communication interface 610 may include a port for receiving a wired connection to an external device (for example, a universal serial bus (“USB”) cabled and the like), a transceiver for establishing a wireless connection to an external device (for example, over one or more communication networks, such as the Internet, local area network (“LAN”), a wide area network (“WAN”), and the like), or a combination thereof In some configurations, the controller 550 can be a dedicated or stand-alone controller. In some configurations, the controller 550 can be part of a system of multiple distinct controllers (e.g., a hub controller, a drive controller, a workgroup controller, etc.) or can be formed by a system of multiple distinct controllers (e.g., also with hub, drive, and workgroup controllers, etc.).

The electronic processor 600 is configured to access and execute computer-readable instructions (“software”) stored in the memory 605. The software may include firmware, one or more applications, program data, filters, rules, one or more program modules, and other executable instructions. For example, the software may include instructions and associated data for performing a set of functions, including the methods described herein.

With further reference to FIG. 6, the controller 550 may receive data signals from the sensors 520 via the communication interface 610. The electronic processor 600 of the controller 550 may request a display template for the operational data from the memory 605. In some example configurations, the memory 605 may store one or more operational data templates for the heads-up display which are operator selectable (e.g., as a display template). In more specific configurations, an operator may customize the operational data to be included within the heads-up display and the relative positioning of the information (e.g., as a custom heads-up display template). Similarly, these custom heads-up display templates may be stored within the memory 605 and be accessible by the electronic processor 600 based upon an operator selection. The electronic processor 600 may then populate the received operational data from the communication interface 610 into the retrieved heads-up display template, after which the electronic processor 600 may transmit the data to be displayed (via the communication interface 610) to the HUD system 505.

Returning to FIG. 5, the power machine 500 may include the HUD system 505. The HUD system 505 may be utilized by the power machine 500 to display information or content to an operator of the power machine 500. Content may also be referred to herein as displayed content or digital content. The displayed content may include media content, such as, e.g., images, videos, etc. As one example, the displayed content may include a real-time (or near real-time video or image data stream of a work site as collected by one or more image sensors or cameras (e.g., the sensor(s) 520).

Alternatively, or in addition, the displayed content may include operational data associated with the operation of the power machine 500, a component of the power machine 500, a work element/implement of the power machine 500, or a combination thereof. For example, the displayed content may include fuel data, an operation or work cycle status, actuator data, torque data, a timer or job clock data, site map data, geographical data, a warning, an alert, maintenance data, etc. In some cases, operational data can include speed, power, extension (e.g., cylinder extension length) or other state information regarding tractive actuators, workgroup actuators, or other powered systems (e.g., climate control and other auxiliary systems). In some cases, operational data for a workgroup can include speed, position or other state information regarding a lift arm, particular components of a lift arm, or various work implements (e.g., buckets, forks, augers, etc.).

Alternatively, or in addition, the displayed content may include augmented data or content. As one example, the displayed content may include one or more augmentations (or virtual representations) of or relating to a geographical zone or boundary (e.g., a boundary of a restricted zone, a digging zone, etc.). As another example, the displayed content may include an obstacle (e.g., a virtual obstacle, a boundary around a virtual obstacle, etc.). As another example, the displayed content may include an optimal path (e.g., an optimal swing path, an optimal digging path, an optimal travel path, etc.). As another example, the displayed content may include a recommendation (e.g., a recommended operating parameter, etc.). As another example, the displayed content may include a work element (e.g., a virtual work element such as when the actual work element is obstructed by the lift arm). As another example, the displayed content may include a work site (e.g., a virtual work site such as when at least a portion of the work site is obstructed by the lift arm, the work element, another type of obstruction, etc.).

Alternatively, or in addition, the displayed content may include virtual operator input devices. As described herein, an operator input device may include, e.g., a hydraulic joystick, a foot pedal, a switch, a button, a knob, a lever, a variable slider, etc. A virtual operator input device may be a graphical representation of an operator input device (e.g., a physical or actual operator input device). An operator of the power machine 500 may interact with the virtual operator input device to control one or more operations (or parameters) associated with the power machine 500. As one example, an operator may interact with a virtual switch (as a virtual operator input device) to control power delivery to an implement attached to an implement carrier (as opposed to interacting with a physical switch). In response to an operator interaction with the virtual switch, one or more of the sensors 520 may detect the interaction and transmit an associated signal to the controller 550. The controller 550 may associate the operator interaction with the displayed virtual switch and vary an operation of the power machine 500 in accordance with the switch function.

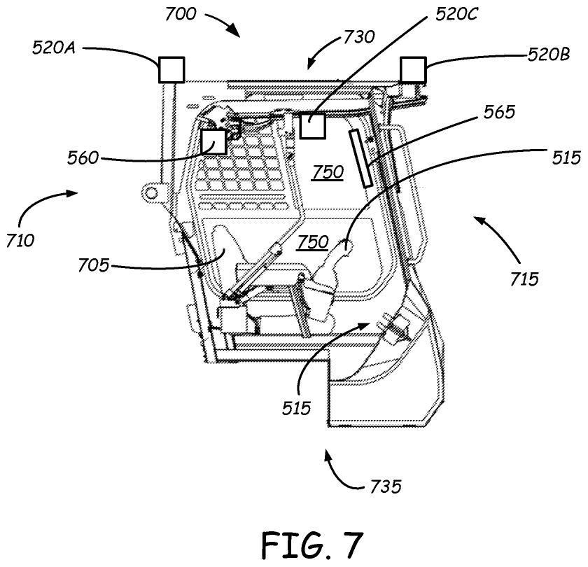

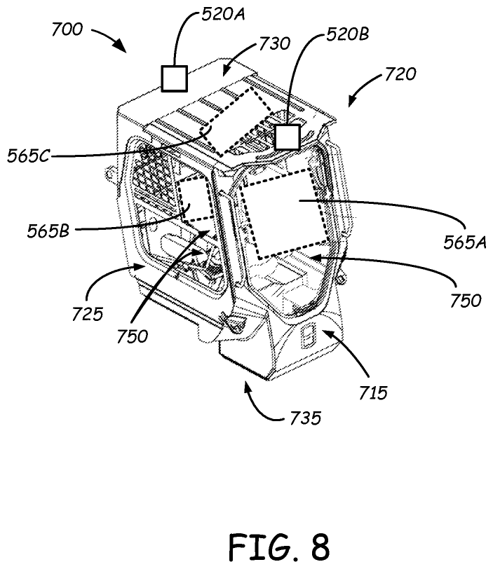

In the illustrated example, the HUD system 505 may include a projection device 560 and a display material 565. The HUD system 505 may include additional, fewer, or different components than those illustrated in FIG. 5 in various configurations and may perform additional functionality than the functionality described herein. For example, the HUD system 505 may include additional, similar, or different components, systems, and functionality as described above with respect to the power machine 100 of FIG. 1, the excavator 200 of FIGS. 2-3, the telescopic handler 400 of FIG. 4, or another power machine described herein. The HUD system 505 is described herein with reference to FIGS. 7-8. FIG. 7 illustrates an example operator station 700 of the power machine 500 according to some configurations. FIG. 8 is a perspective view of the operator station 700 of the power machine 500 according to some configurations. While some examples of the technology disclosed herein may be described with reference to a “cab,” the technology disclosed herein are not intended to be limited in implementation to a cab and may be implemented with differently configured operator stations in other examples.

The projection device 560 may display content on the display material 565. The projection device 560 may be positioned within the operator station 700, as illustrated in FIG. 7. In some specific configurations, the projection device 560 may project an image forward through the cab onto the display material 565 (which may be integrated into one or more windows or doors of the cab). The projected image may then be reflected back to the operator of the power machine 500. Alternatively, or in addition, in some configurations, the projection device 560 may be positioned outside of the operator station 700. In some configurations, the HUD system 505 includes multiple projection devices 560 (e.g., a first projection device, a second projection device, etc.). The projection device 560 can be any suitably configured projection device of the type utilized to provide heads-up display systems. As such, the projection device 560 can be mounted within the operator station 700 in any suitable location which allows the projection of content onto the display material 565 without interfering with the operator of the power machine 500. As one example, in some configurations, the projection device 560 can be positioned above and behind an operator seat 705, as illustrated in FIG. 7. Alternatively, or in addition, in some configurations, the projection device 560 can be positioned below or to a side of the operator seat 705. Alternatively, or in addition, in some configurations, the projection device 560 can be located outside of the operator station 700 but configured to project content (e.g., augmented reality images, video, etc.) into the operator station 700 for display on the display material 565. In some configurations, the projection device 560 may project images, content, and/or video using either laser projection techniques, holographic projection techniques, or the like and can include projecting image areas viewed by the operator as 3D images appearing outside the operator station 700 and the display material 565.

As noted above, the HUD system 505 may also include the display material 565. The display material 565 may be a transparent material, such as a glass or glass -like material (e.g., plexiglass). The display material 565 can be a tinted transparent material. In some configurations, the display material 565 can be a material dedicated for use as a projection screen. In other configurations, the display material 565 can be a portion of material serving other functions within the operator station 700. As one example, in some configurations, the display material 565 used to display content projected by the projection device 560 may be the glass or glass-like material of a front door (as a front side) of the operator station 700.

In some configurations, the display material 565 is integrated into one or more portions of the operator station 700 (e.g., the operator station 150, the operator compartment 250, the cab 252, the operator station 410, etc.). The operator station 700 may provide a position from which an operator can control operation of the power machine 500. In some configurations, the operator station 700 is defined by an enclosed or partially enclosed cab formed from one or more partitions, walls, or surfaces (also referred to herein as “side(s)”). In such a case, a display can be formed by, as, or in a window, door, or other viewing area of the various partitions, walls, or surfaces, or can be otherwise formed as a part of the cab structure (e.g., formed as a display panel embedded into a cab wall, rather than separately included as a stand-alone monitor or other display).

As one example, as illustrated in FIGS. 7-8, the operator station 700 may include a back side 710, a front side 715, a first lateral side 720, a second lateral side 725, a top side 730, and a bottom side 735. For instance, FIG. 7 is a side view of the first lateral side 720 of the operator station 700 of the power machine 500. Accordingly, in some configurations, the display material 565 can be integrated into one or more of the sides 710, 715, 720, 725, 730 of the operator station 700. In some configurations, the display material 565 is integrated into multiple sides of the operator station 700 (e.g., into the front side 715 and either of the first or second lateral sides 720, 725; into the top side 730 and the front side 715; into the top side 370 and either of the first or second lateral sides 720, 725; etc.).

As used herein in the context of a power machine, unless otherwise defined or limited, the term “lateral” refers to a direction that extends at least partly to a left or a right side of a front-to-back reference line defined by the power machine. Accordingly, for example, a lateral side wall of a cab of a power machine can be a left side wall or a right side wall of the cab, relative to a frame of reference of an operator who is within the cab and is oriented to operatively engage with controls of an operator station of the cab.

As one example, FIG. 8 illustrates a first display material 565A integrated into the front side 715 of the power machine 500 and a second display material 565B integrated into the first lateral side 720 of the power machine 500. According to this example, content may be provided to an operator of the power machine 500 in front of the operator (via the first display material 565A) and to the right of the operator (via the second display material 565B). As another example, FIG. 8 also illustrates a third display material 565C integrated into the top side 730 of the power machine 500. According to this example, the content may be provided to an operator of the power machine 500 in front of the operator (via the first display material 565A), to the right of the operator (via the second display material 565B), above the operator (via the third display material 565C), or a combination thereof.

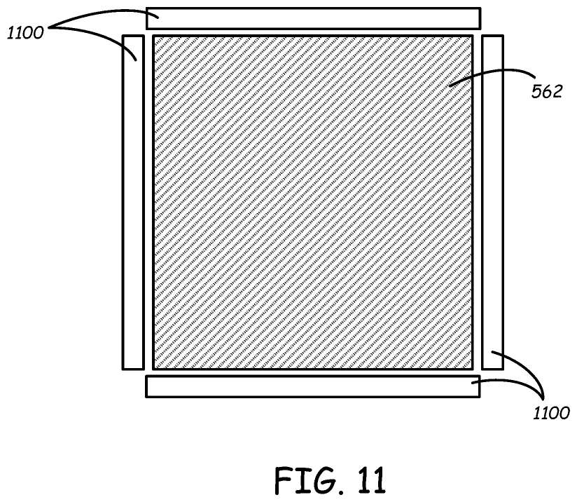

Accordingly, in some configurations, the display material 565 may be positioned such that the display material 565 is within an operator's line of sight (e.g., during operation of the power machine 500). The display material 565, when implemented as part of the integrated display panel 562 as illustrated in FIG. 11, can be positioned such that the content is more within the operator's line of sight of the work area than is the case with conventional display panels mounted in upper or lower corners of the cab. This may reduce the necessity for the operator to look away from the work area while operating the power machine 500. Instead, the display material 565 allows the operator to observe displayed content while continuing to look generally toward the work area.

Displaying the information generally in the operator's line of sight to the work area, as can be the case with a HUD configuration, provides advantages in that the operator can maintain better situational awareness about the work area. For instance, with respect to the third display material 565C of FIG. 8, the third display material 565C enables an operator to view content within the operator's line of site such as when the operator is lifting a payload above the operator station 700 (e.g., when the power machine 500 is the telescopic handler 400 of FIG. 4).

With respect to any of the first, second, and third displays resulting from the use of the one or more projection devices 560 with the display materials 565A-C, the displays may provide the operator with an unobstructed view from the operation station of the power machine 500 regardless of visual obstructions (e.g., work group elements, implements, tractive elements, etc.) by augmenting the operator's field of view with image data (e.g., images or videos) from the one or more sensors 520 with secondary fields-of-view that do not include the visual obstructions.

The display material 565, however, provides further advantages relative to a heads-up display. As one example, in exemplary configurations, the display material 565 may include (or be implemented with) a touch screen interface allowing the operator to control the display of content, enter data, or otherwise interact with the display material 565.

In some configurations, as illustrated in FIGS. 7-8, a side of the operator station 150 may include one or more transparent portions 750 (e.g., glass, tempered glass, etc.). In some configurations, one or more of the displays may include the display material 565 and an array of organic light emitting diode. The display may be affixed with an adhesive to or otherwise secured to or formed in a side of the operator station 700. In some configurations, the display is secured to or formed in the transparent portions 750 of a side of the operator station 700. When integrated into the transparent portions 750, the display may be positioned between two layers of class, for example. In some configurations, a bonding process glues the display material 565 to the side using any suitable adhesion to glass techniques and materials. However, in exemplary configurations, the transparent portions 750 of the side to which the display material 565 can be adhered to is tempered (e.g., tempered glass). In other configurations, the display may utilize other display technologies such as liquid crystal display. In various configurations, the display material 565 may be transparent enough to allow an operator to see through the transparent portion 750 reasonably well (e.g., when the display is not in use) while at the same time providing a visible, clear image when content is projected on the display material 565.

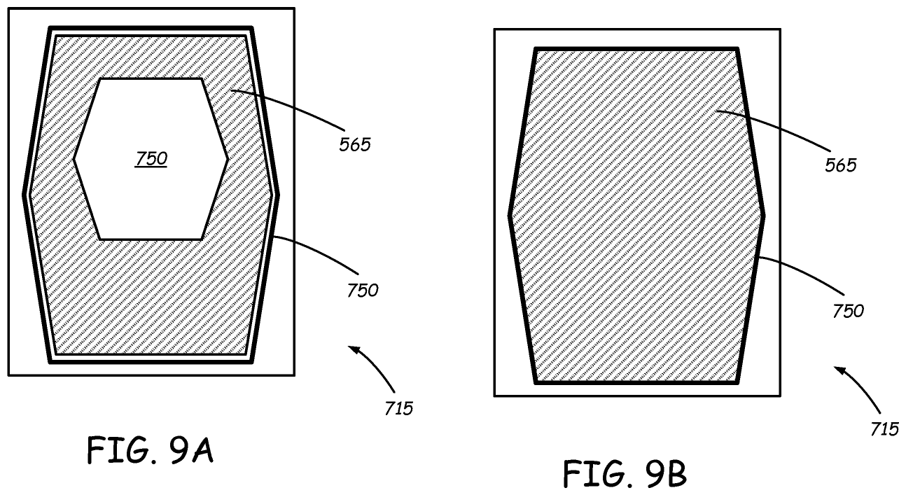

FIGS. 9A-9B illustrate the transparent portion 750 of the front side 715 of the power machine 500 according to some configurations. As illustrated in FIGS. 9A-9B, the display material 565 is integrated into at least a portion of the transparent portion 750. As one example, as illustrated in FIG. 9A, the display material 565 is integrated into the transparent portion 750 such that at least a portion of the transparent portion 750 does not include the display material 565. As a result, at least a portion of the transparent portion remains unobstructed when content is displayed on the display material 565. In the example of FIG. 9A, the unobstructed portion of the transparent portion 750 may enable an unobstructed line of sight for the operator with respect to a work site (e.g., such that the display material 565 does not obstruct the operator's line of sight).

In some configurations, as illustrated in FIG. 9B, the entire transparent portion 750 may be integrated with the display material 565. In such configurations, the controller 550 may control how content is displayed such that an operator's line of site is not overlaid by content. Accordingly, in some configurations, the controller 550 may monitor a gaze of an operator and control the display of content such that the operator's actual line of sight (e.g., the gaze) is not overlaid by displayed content. Alternatively, or in addition, the controller 550 may modify a display parameter based on an operator's gaze. As one example, the controller 550 may adjust a transparency parameter of the displayed content such that an operator may more easily see-through displayed content (e.g., reduce brightness).

In other configurations, displayed content may be presented with low light to minimize obstruction of the operator's view. In response to tracking of an operator's line of sight towards one or more displayed content areas on the display material 565, the brightness of the display may be temporarily increased (until the operator's line of sight moves away from the display material 565).

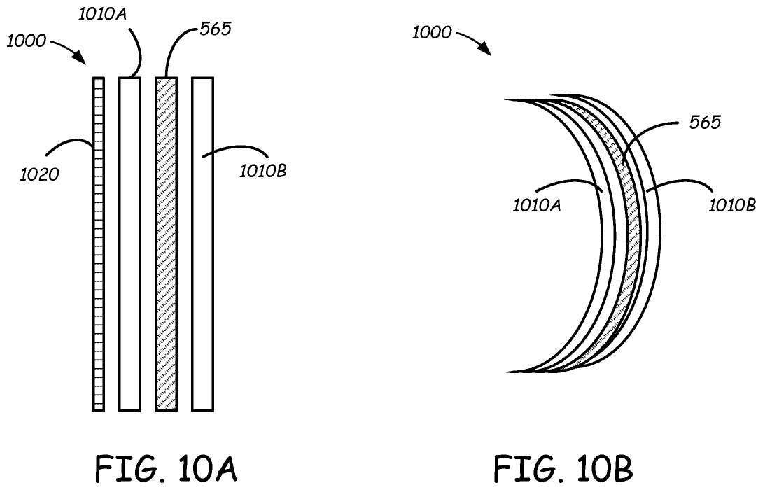

In some configurations, the display material 565 may be positioned between layers of transparent material (e.g., glass, tempered glass, etc.). For instance, FIGS. 10A-10B illustrate a side view of an example portion 1000 of a side of the operator station 700 according to some configurations. In the illustrated example, the portion 1000 includes a set of layers. The set of layers may include a first transparent layer 1010A, the display material 565, and a second transparent layer 1010B. As illustrated in FIGS. 10A-10B, the display material 565 is positioned between the first transparent layer 1010A and the second transparent layer 1010B. In some configurations, as illustrated in FIG. 10B, the set of layers may be concave. In such configurations, each layer (e.g., the first transparent layer 1010A, the display material 565, and the second transparent layer 1010B may be concave).

In some specific applications, the display material 565 may be one or more thin-film layers (also referred to as thin laminate films) which are adhered to a window or door of the power machine 500. The one or more thin film layers may include material characteristics which are semi-transparent and semi-reflective—whereby a projected image is reflected off of the display material 565 and visible to the operator while also allowing for the transmission of light from outside the cab. In one specific experimental configuration, the display material 565 may include one or more thin laminate film layers of polyethylene terephthalate (also known as PET). PET is a thermoplastic polymer resin of the polyester family.

In some configurations, as illustrated in FIG. 10A, a touch sensitive material 1020 is coupled to a layer of transparent material (e.g., the first transparent layer 1010A) and aligned with the display material 565 such that, in response to an operator touching the touch sensitive material 1020, coordinates are related to the controller 550 to provide user input. In practice, the controller 500 associated with an operator contacted portion of the display with a displayed virtual button and modifies one or more operating characteristics of the power machine 500 consistent with the virtual button function. Using this input technique, the controller 550 may be programmable to allow the operator to select areas on the integrated display panel 562 (e.g., the display material 565) where information is to be displayed and where an operator can locate user inputs. Alternatively, or in addition, the controller 550 may detect user interactions with the displayed content using this input technique. The touch sensitive material 1020 may include one or more layers that facilitate identification of user interactions via one or more known methodologies. As one example, capacitive or pressure sensitive.

Alternatively, or in addition, in some configurations, user interaction with the integrated display panel 562 may be detected based upon operator hand/finger position in proximity with the display. As one example, as illustrated in FIG. 11, infrared light curtain devices or light bars 1100 (referred to herein as “the light devices 1100”) may be positioned proximate to the display material 565. The light devices 1100 may project and sense infrared light to generate an infrared light curtain proximate a surface of a side of the power machine 500, in alignment with the display material 565. In response to sensing an object (e.g., an operator's finger, a stylus, etc.) using the infrared light curtain, the light devices 1100 provide coordinates related to the display material 565 to the controller 550. The display material 565 and the controller 550 may allow the operator, by input through the sensing the object using the infrared light curtain, to select areas on a side of the power machine 500 where operational information or user inputs are displayed (e.g., the displayed content). Using the infrared light curtain may enable the operator to wear gloves, which may not be sensed by some touch sensitive material technologies. While the light devices 1100 are shown on all four sides of the display material 565, in some configurations (not illustrated), the light devices 1100 are associated with sensors and receivers on each bar that can be positioned along one of a top and bottom and one of each side so that a single light bar extends vertically and a single light bar extends horizontally.

In some specific configurations, operator gesture detection may be captured and associated with intended user inputs such as virtual buttons depicted on a display panel. For example, an operator may point to a displayed virtual button (without contacting the display). A camera or image sensor within the cab of the power machine may detect the operator gesture and an electronic processor of the controller, using image recognition, identifies a user's hand/finger in one or more images received from the camera/image sensor and determines a trajectory of the hand/finger relative to the display panel. Finally, the gesture is associated with an intended virtual button of the display panel and the controller modifies the operating characteristics of the power machine 500 in accordance with the virtual button functionality. In some specific configurations, the camera/image sensor within the cab may be used to capture and identify specific operator hand gestures associated with a specific function of the power machine 500. In one example, a clockwise rotating finger in the area may be identified by gesture detection circuitry within the electronic processor and cause the power machine 500 to increase the velocity of the power machine and/or increase motor/engine rotations per minute. The detection of a clenched fist with a forward direction by the electronic processor may cause the power machine 500 to move forward with a speed associated with how far forward the clenched fist is moved relative to a neutral position within a space defined by the cab. Similarly, moving the clenched fist left, right, or backward may cause corresponding motions of the power machine 500.

Returning to FIG. 5, the power machine 500 may also include a set of sensors 520. The sensor(s) 520 may include an image sensor, a thermal image sensor, a radar sensor, a light detection and ranging (“LIDAR”) sensor, a sonar sensor, a near infrared (“NIR”) sensor, a camera, etc. As used herein, an image sensor is a sensor that detects and conveys information used to make an image. Accordingly, an image sensor may include traditional CMOS image sensors or devices as well as other imaging sensors. Alternatively, or in addition, the sensor(s) 520 may include a, e.g., a pressure sensor, a temperature sensor, a speed sensor, a position sensor, an accelerometer, etc. The sensor(s) 520 may collect or detect data associated with a work site, the power machine 500 (or a component thereof), or a combination thereof. In some configurations, one or more of the sensors 520 may be positioned within the operator station 700. Alternatively, or in addition, in some configurations, one or more of the sensors 520 may be positioned outside of the operator station 700. The controller 550 of the power machine 500 may display operational characteristics of the power machine 500 based on output signals/data from the one or more sensors 520.

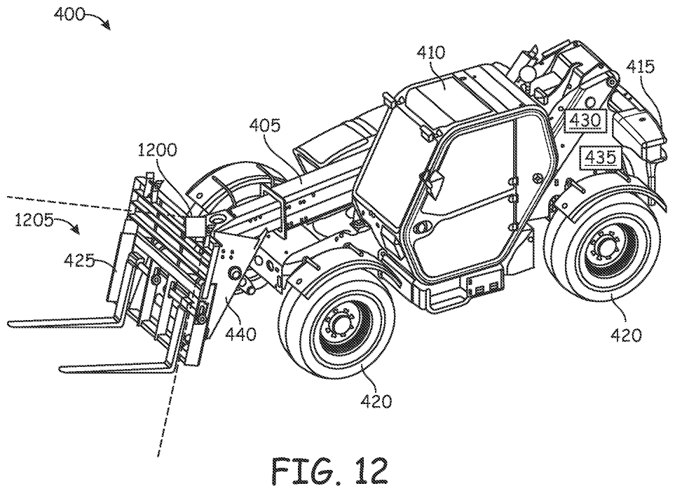

As one example, FIG. 7 illustrates a first sensor 520A, a second sensor 520B, and a third sensor 520C, which may be image sensors. In the illustrated example the first sensor 520A is mounted external to the operator station 700 such that the first sensor 520A collects data associated with a rear environment or surrounding of the power machine 500. The second sensor 520B is mounted external to the operator station 700 such that the second sensor 520B collects data associated with a front environment or surrounding of the power machine 500. The third sensor 520C is mounted internally to the operator station 700 such that the third sensor 520C collects data associated with an internal environment or surrounding of the operator station 700 (e.g., the operator, the operator's gaze, etc.). As another example, as illustrated in FIG. 12, the telescopic handler 400 may include a sensor 1200 (similar to the sensor 520 illustrated in FIG. 7) within proximity of the work element 425. For instance, in some configurations, the sensor 1200 may be mounted on the work element 425, the implement interface 440, or the lift arm 405 (e.g., on a telescoping, distal end thereof). Providing the sensor 1200 (e.g., as an image sensor) may enable the displayed content to include a video or image feed with respect to performing a work task with the work element 425, which may be obstructed from the operator's line of sight during operation of the telescopic handler 400 (or another power machine as described herein). For example, a front display of the telescoping handler 400 can be used to display video images of a field of view 1205 that extends at least partly into an area of the surrounding environment that is blocked by the lift arm 405, the work element 425, or the implement interface 440 from the perspective of an operator within the operator station 410. In some cases, different displays on the telescopic handler 400 or on other power machines can be used for similar effect, including as can generally allow an operator to effectively see through solid components of the power machine or other obstructions.

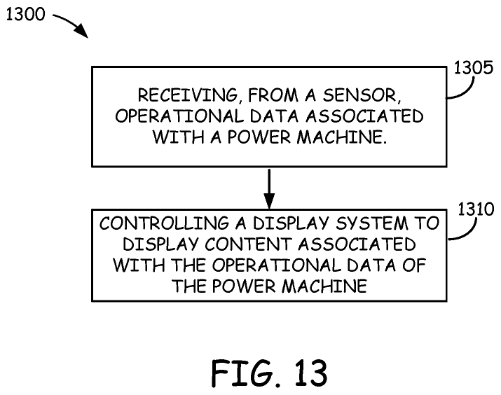

FIG. 13 is a flowchart illustrating a method 1300 for operating a power machine (for example, the power machine 500) according to some configurations. In some configurations, the method 1300 can be performed by the control system 510 (e.g., the controller 550) and, in particular, by the electronic processor 600 of the controller 550. However, as noted above, the functionality described with respect to the method 1300 may be performed by other devices or can be distributed among a plurality of devices or components.

As illustrated in FIG. 13, the method 1300 includes receiving, with the electronic processor 600, operational data associated with the power machine 500 (at block 1305). The operational data may include, e.g., one or more operational settings or parameters of the power machine 500 (e.g., sensed operational parameters, operator inputs, etc.), data collected or sensed by one or more of the sensors 520, or the like. In some configurations, the operational data may be received from an operator input device, one or more of the sensors 520, or the like. As one example, the operational data may include a real-time (or near real-time) video or image data stream collected by an image sensor (e.g., the sensor 520) associated with an operation of the power machine 500. The electronic processor 600 may then control the HUD system 505 to display content associated with the operational data of the power machine 500 (at block 1310). As described in greater detail herein, the electronic processor 600 (e.g., the controller 550) may control the HUD system 505 to provide the displayed content to an operator of the power machine 500. For instance, in some configurations, the electronic processor 600 may control the projection device 560 to project the displayed content onto the display material 565.

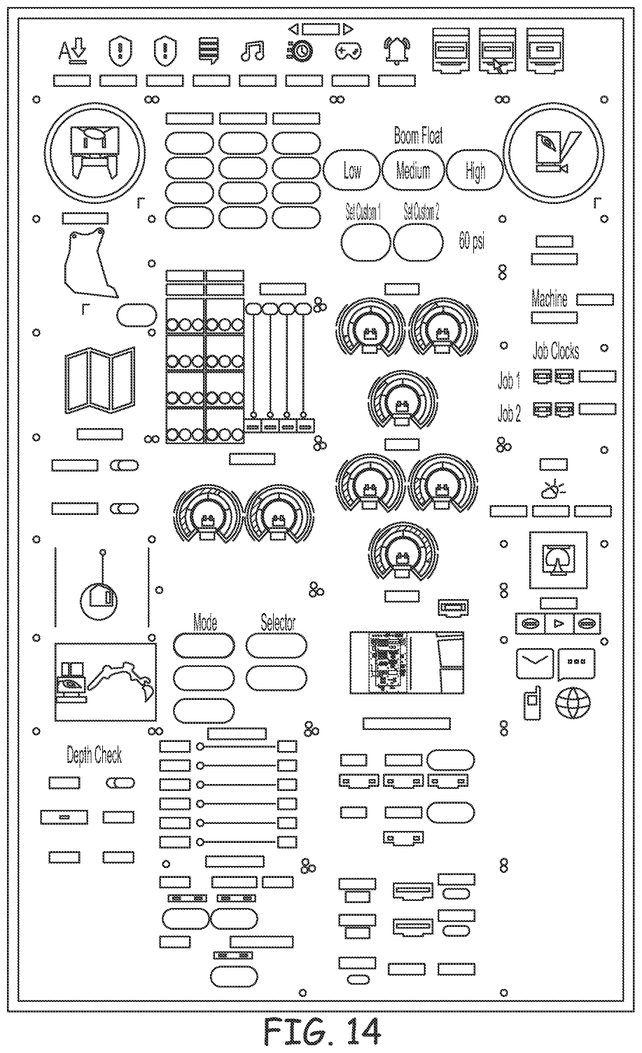

FIG. 14 illustrates example displayed content according to some configurations. As illustrated in FIG. 14, the displayed content may display operational parameters of the power machine 500 (or components thereof). For example, the displayed content may include an operational parameter of the boom, including, e.g., a boom float parameter. As another example, the displayed content may include an orientation of the power machine 500 (or components thereof), where the orientation may be provided as a graphical representation of the power machine 500 (or components thereof) at a present orientation or a numerical value or other indicator of a present orientation. In some examples, the displayed content may include a graphical representation of the power machine 500 (or components thereof) being used (e.g., excavator 200 of FIG. 2 or 3, or telescopic handler 400 of FIG. 4). For example, when the power machine 500 is a telescopic handler, the displayed content may include a graphical representation of a telescopic handler, where the graphical representation may depict an implement of the telescopic handler pursuant to a present orientation or position of the implement of the telescopic handler. In some examples, the displayed content may include one or more timers or job clocks. In some examples, the displayed content may depict operator control devices as user interface elements, such as, e.g., input controls, including, e.g., checkboxes, radio buttons, menus, sliders, scrollbars, buttons, knobs, dials, meters, etc.

Also as illustrated in FIG. 14, the displayed content may include various user interface elements, including, input controls, navigational components, informational components, etc. In some examples, the displayed content may include communication related functionality or information. Additionally, the displayed content may include various type of parameters according to the operator's preferences (e.g., via a customized heads-up display template, as described in greater detail herein). For example, the operator may create a customizable displayed content to display via display material 565.

In some specific experimental configurations, video/image sensor data may be overlaid on an operator's external view from the cab of the power machine 500 via a display integrated into the cab door glass and/or windows. For example, a front-facing view of the operator may be partially obscured by one or more components of the power machine 500 (e.g., a work group, implement carrier, implement, tractive elements, etc.), other power machines in close proximity, other job site equipment, etc. Obstructions to the operators view from the cab may be mitigated/eliminated based upon data from video/image sensor data with different perspectives/fields-of-view than the operator; particularly, fields-of-view that exclude the one or more operator view obstructions. In some implementations, this may include positioning video/image sensors on the top of the cab and/or low on the power machine chassis. All or a portion of the unobstructed view from the provided sensor data (particularly where the obstruction lies in the operator's view) may then be overlaid on a transparent display positioned within the operator's front-facing view. The result is a seamless, augmented reality view for the operator of the power machine 500 devoid of the one or more view obstructions. Based upon the transmissive characteristics of the display (in use), the operator may only see the unobstructed displayed image or simultaneously see the obstruction and the overlaid unobstructed view.

In some embodiments, aspects of the disclosed technology, including computerized implementations of methods according to the disclosed technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosed technology can be implemented as a set of instructions, tangibly embodied on a non-transitory computer-readable media, such that a processor device can implement the instructions based upon reading the instructions from the computer-readable media. Some embodiments of the disclosed technology can include (or utilize) a control device such as an automation device, a special purpose or general purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the disclosed technology, or of systems executing those methods, may be represented schematically in the FIGs. or otherwise discussed herein. Unless otherwise specified or limited, representation in the FIGs. of particular operations in particular spatial order may not necessarily require those operations to be executed in a particular sequence corresponding to the particular spatial order. Correspondingly, certain operations represented in the FIGs., or otherwise disclosed herein, can be executed in different orders than are expressly illustrated or described, as appropriate for particular embodiments of the disclosed technology. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g. “one or the other but not both”) when preceded by terms of exclusivity, such as “either,” “one of,” “only one of,” or “exactly one of.”

Also as used herein, unless otherwise specified or limited, the terms “about” and “approximately” as used herein with respect to a reference value refer to variations from the reference value of ±20% or less (e.g., ±15, ±10%, ±5%, etc.), inclusive of the endpoints of the range. Similarly, as used herein with respect to a reference value, the term “substantially equal” (and the like) refers to variations from the reference value of less than ±5% (e.g., ±2%, ±1%, ±0.5%) inclusive. Where specified in particular, “substantially” can indicate a variation in one numerical direction relative to a reference value. For example, the term “substantially less” than a reference value (and the like) indicates a value that is reduced from the reference value by 30% or more (e.g., 35%, 40%, 50%, 65%, 80%), and the term “substantially more” than a reference value (and the like) indicates a value that is increased from the reference value by 30% or more (e.g., 35%, 40%, 50%, 65%, 80%).

Although the present technology disclosed herein has been described by referring to preferred embodiments, workers skilled in the art will recognize that changes may be made in form and detail without departing from the scope of the discussion.

What is claimed is:

1. A power machine comprising:
an operator station having a plurality of sides and supported by a frame of the power machine, the operator station including:
an operator input device configured to receive operator inputs to control movement of a lift arm of the power machine; and
a display system configured to electronically display content, the display system having a set of displays that includes a first display integrated into a first side of the operator station and a second display integrated into a second side of the operator station; and
a control system that includes a controller in electronic communication with the display system, the controller being configured to:
receive, from a sensor, operational data associated with the power machine; and
control the display system to display, via the first display and the second display, content associated with the operational data of the power machine.

2. The power machine of claim 1, wherein the sensor is an image sensor and the displayed content includes a video data stream associated with an operation of the power machine.

3. The power machine of claim 2, further comprising:
the frame that supports the operator station; and
a workgroup supported by the frame, the workgroup including the lift arm moveably secured to the frame;
wherein the lift arm is an extendable lift arm and the sensor is supported at an end of the lift arm that is opposite the frame.

4. The power machine of claim 3, wherein the sensor is supported by one or more of an implement carrier secured to the lift arm or an implement operably secured to the lift arm.

5. The power machine of claim 1, wherein the display system is a heads-up display system.

6. The power machine of claim 1, wherein the operator station is a cab and the first side of the operator station is a top side of the cab.

7. The power machine of claim 1, wherein the operator station is a cab and the first side of the operator station is a back side of the cab.

8. The power machine of claim 1, further comprising:
the frame that supports the operator station; and
a workgroup supported by the frame, the workgroup including the lift arm moveably secured to the frame;
wherein the sensor is an image sensor having a field of view that at least partly includes the lift arm, with the lift arm in a fully lowered or a fully raised orientation.

9. The power machine of claim 1, wherein the sensor is an image sensor having a field of view directed to behind the operator station.

10. The power machine of claim 1, wherein the sensor is mounted on a lift arm of the power machine.

11. The power machine of claim 1, further comprising:
the frame;
a workgroup supported by the frame, the workgroup including the lift arm moveably secured to the frame, and an implement carrier or implement carrier movably secured to the lift arm;
a power system including:
a workgroup power system that includes one or more actuators configured to move the lift arm or the implement carrier; and
a power source configured to power movement of the one or more actuators;
wherein the sensor is a workgroup sensor configured to sense operational data associated with the workgroup or the workgroup power system; and
wherein the controller is further configured to:
receive, from a power system sensor, operational data associated with the power system; and
further control the display system to display content associated with the operational data from the power system sensor.

12. The system of claim 1, wherein the content includes video representation of a field of view that is at least partially obstructed by the lift arm of the power machine from within the operator station.

13. A method comprising:
receiving, with one or more electronic processors, from an image sensor, operational data associated with a work element of a power machine; and
controlling, with the one or more electronic processors, a display system of the power machine to display, via a plurality of displays integrated into sides of an operator station of the power machine, content based on the operational data,
wherein the power machine includes a telescopic lift arm and the image sensor is supported on a distal end of the telescopic lift arm.

14. The method of claim 13, wherein the plurality of displays includes at least one transparent organic light emitting device.

15. The method of claim 14, wherein the content includes video representation of a field of view that is at least partially obstructed by the telescopic lift arm from within the operator station that includes the display system.

16. The method of claim 13, wherein controlling the display system of the power machine to display, via the plurality of displays, content based on the operational data includes controlling the display system of the power machine to display, via the plurality of displays, content on at least two of:
a first display of the plurality of displays integrated into a lateral side of the operator station, a second display of the plurality of displays integrated into a back side of the operator station, a third display of the plurality of displays integrated into a front side of the operator station, or a fourth display of the plurality of displays integrated into a top side of the operator station.

17. An operator station for a power machine, the operator station comprising:
a display system configured to display content, the display system having a set of displays that includes a first display integrated into a first side of the operator station and a second display integrated into a second side of the operator station; and
the display system being in electronic communication with a control system that includes a controller in electronic communication with the display system, to be controlled by the controller to display content based on operational data of the power machine received by the controller.

18. The operator station of claim 17, wherein the first side of the operator station is a top side or a back side of the operator station and a second side of the operator station is a lateral side of the operator station.

19. The operator station of claim 17,
wherein the set of displays includes a third display integrated into a third side of the operator station and a fourth display integrated into a fourth side of the operator station; and
wherein the first side of the operator station is a top side of the operator station, the second side of the operator station is a back side of the operator station, the third side of the operator station is a lateral side of the operator station, and the fourth side of the operator station is a front side of the operator station.

20. The operator station of claim 17, wherein the content includes video representation of a field of view that is at least partially obstructed by a work element of the power machine from within the operator station.
